(19) United States
(12) Patent Application Publication
(10) Pub. No.: US 2026/0233800 A1
(43) Pub. Date: Aug. 13, 2026

(54) HANDLEBAR ASSEMBLY

(71) Applicant: Also, Inc., Palo Alto, CA (US)

(72) Inventors: Arth Nireshkumar PATEL, San Jose, CA (US); Jonathan Louis HALL, Menlo Park, CA (US); Islam Mohsen SHAWKI, Sunnyvale, CA (US); David REYES, Woodside, CA (US); Adam Christopher BENDER, San Francisco, CA (US); Mark Oliver Dixon KAUFMAN, San Jose, CA (US)

(73) Assignee: Also, Inc., Palo Alto, CA (US)

(21) Appl. No.: 19/537,018

(22) Filed: Feb. 11, 2026

Related U.S. Application Data
(63) Continuation-in-part of application No. 19/206,745, filed on May 13, 2025.
(60) Provisional application No. 63/757,439, filed on Feb. 12, 2025.

(51) Int. Cl. B62K 21/12; B62K 23/06

(52) U.S. Cl. CPC B62K 21/12; B62K 21/125; B62K 23/06

(57) ABSTRACT

Systems, methods, and apparatuses of a handlebar assembly are provided. The handlebar assembly can include a frame unit to couple with a frame of a bike. The mechanical frame unit can include a mechanical frame connector. The mechanical frame connector can include a release element to allow the mechanical frame connector to move between a retention position and a release position. The handlebar assembly includes an electrical frame connector. The handlebar assembly includes a handlebar to couple with the frame unit. The handlebar includes a handle to couple with the mechanical frame connector such that the handle extends from the mechanical frame connector. A handlebar connector having a first end to couple with the handle and a second end to couple with the electrical frame connector to couple the handlebar with an electrical system of the bike.

### CROSS-REFERENCE TO RELATED APPLICATION

This U.S. Patent Application claims the benefit of and priority to U.S. Provisional Application No. 63/757,439, filed February 12, 2025, and is a Continuation-in-Part of U.S. Patent Application No. 19/206,745, filed May 13, 2025, the entire disclosures of which are hereby incorporated by reference herein for all purposes.

### BACKGROUND

Vehicles can include passengers and be used to convey the passengers from one location to another.

### SUMMARY

At least one aspect is directed to a handlebar assembly. The handlebar assembly can include a frame unit configured to couple with a frame of a bike. The mechanical frame unit can include a mechanical frame connector. The mechanical frame connector can include a release element configured to allow the mechanical frame connector to move between a retention position and a release position. The handlebar assembly includes an electrical frame connector. The handlebar assembly includes a handlebar to couple with the frame unit. The handlebar includes a handle to couple with the mechanical frame connector such that the handle extends from the mechanical frame connector. A handlebar connector can include a first end to couple with the handle and a second end to couple with the electrical frame connector to couple the handlebar with an electrical system of the bike.

At least one aspect is directed to a bike. The bike can include a frame. The bike can include a first wheel and a second wheel rotatably coupled with the frame. The bike can include a frame unit to couple with a frame. The bike can include a steering member positioned within the frame. The bike can include a frame unit. The frame unit can couple with the frame and with the steering member. The frame unit can include a mechanical frame connector including a release element to allow the mechanical frame connector to move between a retention position and a release position. The frame unit can include an electrical frame connector. The bike can include a handlebar to couple with the frame unit and to steer the bike via the steering member. The handlebar can include a handle to couple with the mechanical frame connector such that the handle extends from the mechanical frame connector. The handlebar can include a handlebar connector having a first end to couple with the handle and a second end to couple with the electrical frame connector to couple the handlebar with an electrical system of the bike.

At least one aspect is directed to a method. The method can include providing a frame unit to couple with a frame of a bike. The frame unit can include a mechanical frame connector and an electrical frame connector. The method can include providing a handlebar to couple with the frame unit. The handlebar can include a handle and a handlebar connector having a first end and a second end opposite the first end. The method can include coupling the handle with the mechanical frame connector such that the handle extends from the mechanical frame connector. The method can include coupling the handlebar connector with the electrical frame connector to couple the handlebar with an electrical system of the bike.

At least one aspect is directed to a method. The method can include providing a handlebar assembly. The handlebar assembly can include a frame unit to couple with a frame of a bike. The mechanical frame unit can include a mechanical frame connector. The mechanical frame connector can include a release element to allow the mechanical frame connector to move between a retention position and a release position. The handlebar assembly includes an electrical frame connector. The handlebar assembly includes a handlebar to couple with the frame unit. The handlebar includes a handle to couple with the mechanical frame connector such that the handle extends from the mechanical frame connector. The handlebar includes a handlebar connector. The handlebar connector can have a first end to couple with the handle and a second end to couple with the electrical frame connector to couple the handlebar with an electrical system of the bike.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an example electric vehicle.

FIG. 2 depicts a perspective view of an example handlebar assembly.

FIG. 3 depicts a perspective view of an example handlebar assembly.

FIG. 4A depicts a detailed view of an example handlebar.

FIG. 4B depicts an exploded view of an example handlebar.

FIG. 5 depicts a detailed view of an example frame unit.

FIG. 6 depicts an exploded view of an example frame unit.

FIG. 7 depicts an exploded view of an example frame unit.

FIG. 8 depicts a perspective view of an example handlebar assembly.

FIG. 9 depicts a perspective view of an example frame and brake connector.

FIG. 10 depicts a perspective view of a portion of an example frame unit.

FIG. 11 depicts a partially exploded view of an example frame unit.

FIG. 12 depicts a sectional view of an example handlebar assembly.

FIG. 13 depicts a perspective view of an example handlebar assembly.

FIG. 14 depicts a sectional view of an example handlebar assembly.

FIG. 15 depicts an example handlebar connector.

FIG. 16 depicts an example handlebar connector.

FIG. 17 depicts an example sectional view of a handlebar connector.

FIG. 18 depicts a flow diagram of an example method of producing a handlebar assembly.

FIG. 19 depicts a flow diagram of an example method of providing a handlebar assembly.

### DETAILED DESCRIPTION

Following below are more detailed descriptions of various concepts related to, and implementations of, methods, apparatuses, and systems of integrating an apparatus into a frame or chassis of a bike. The various concepts introduced above and discussed in greater detail below may be implemented in any of numerous ways.

This technical solution is generally directed to a handlebar assembly that can include a handlebar configured to easily connect to and disconnect from a bike, such as an electric bike (“e-bike”). The handlebar assembly allows a rider to change a handlebar configuration of the bike based on the rider’s preferred riding style or the intended riding scenario. For example, the handlebar assembly can include a first handlebar that corresponds to a first riding style (e.g., leisure). The first handlebar can be swapped out for a second handlebar that corresponds to a second riding style (e.g., sport). The handlebars can be easily interchangeable by the rider with or without the use of tools.

The disclosed solutions have the technical advantage of accommodating various handlebars for a bike that can easily connect to and disconnect from other mechanical and electrical systems of the bike. For example, the handlebar assembly can include a frame unit configured to couple with the handlebar. The frame unit can include various connection points corresponding to the various systems of the bike. The handlebar can include corresponding connection points that can easily couple with the connection points of the various systems when coupled with the frame unit. The connection of the handlebar with the frame unit can include a quick connection method (e.g., snap into place, install fastener) and the disconnection from the frame unit can include a quick disconnection method (e.g., actuate a release mechanism, remove a fastener).

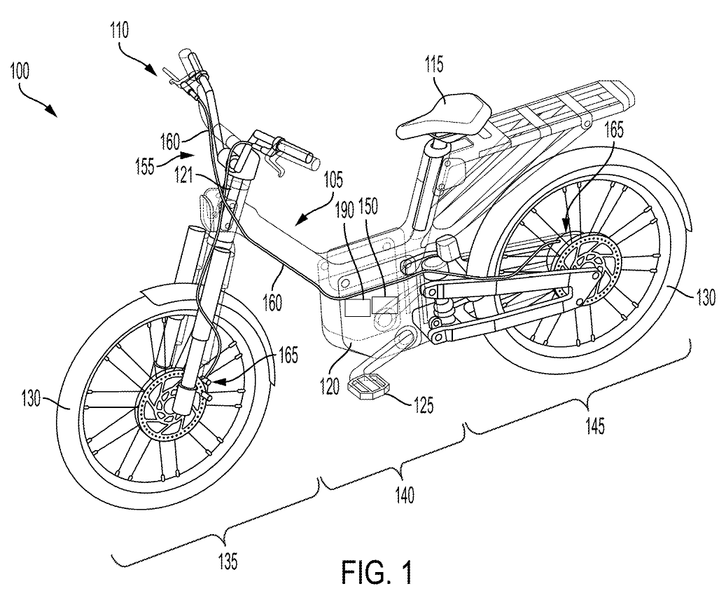

FIG. 1, among others, depict an example perspective view of a micromobility device, shown as an electric bike (e.g., bike 100). The electric bike 100 can be or can include any vehicle or micromobility device that can carry at least one rider, is operable by at least one motor, and includes at least one wheel or similar movement component (e.g., single rider bicycles, tandem bicycles, cargo bicycles, motor-assist bicycles, pedicabs, electric-assist bicycles, road bicycles, mountain bicycles, motorcycles, unicycles, electric scooters, or segways, among others).

The bike 100 can include at least one frame 105 (e.g., chassis). The frame 105 can support various components of the bike 100, such as a handlebar assembly 110, a saddle 115, or a drive unit 120 having one or more batteries, motors, and other components. The frame 105 can include at least one structural member. For example, the frame 105 can include a steering member 121. The steering member 121 can facilitate directional control (e.g., steering) of the bike 100. For example, the steering member 121 can support and couple with the handlebar assembly 110. A rider can steer the bike 100 by moving the handlebar assembly 110. The bike 100 can include at least one propulsion element, shown as a pedal 125. Force applied to the pedal 125 can facilitate operation of the bike 100. For example, a force that causes the pedal 125 to move can cause the bike 100 to move forward.

The bike 100 can include at least one traction element, shown as a wheel 130. For example, the bike 100 can include a first wheel 130 and a second wheel 130. The bike 100 can have a front wheel 130 and a rear wheel 130. The front wheel 130 can couple with the steering member 121 such that movement of the handlebar assembly 110 can cause movement of the front wheel 130. The bike 100 can include any number of wheels 130 (e.g., one wheel, two wheels, three wheels, or more wheels). The frame 105 can include a front portion 135. The front portion 135 can support, be coupled with, or include, for example, a front wheel 130 and a handlebar assembly 110. The frame 105 can include a middle portion 140. The middle portion 140 can support, be coupled with, or include, for example, a saddle 115, a drive unit 120, or a pedal 125 of the bike 100, among other components. The frame 105 can include a rear portion 145. The rear portion 145 can support, be coupled with, or include, for example, a rear wheel 130, a drive train of the bike 100, a suspension assembly of the bike 100, or a rack of the bike 100, among other components.

The bike 100 can be fully electric or partially electric (e.g., pedal-powered) and further, the bike 100 can be fully autonomous, partially autonomous, semi-autonomous, or unmanned. The bike 100 can also be human operated or non-autonomous. A human operator or the rider of the bike 100 can sit on a saddle 115 to operate the bike 100. The rider of the bike 100 can steer, grip, balance, or otherwise control the bike 100 using the handlebar assembly 110. The bike 100 can include a control device 190. The control device 190 can be a printed circuit board assembly (PCBA), a CAN controller, or some other controller or computing system.

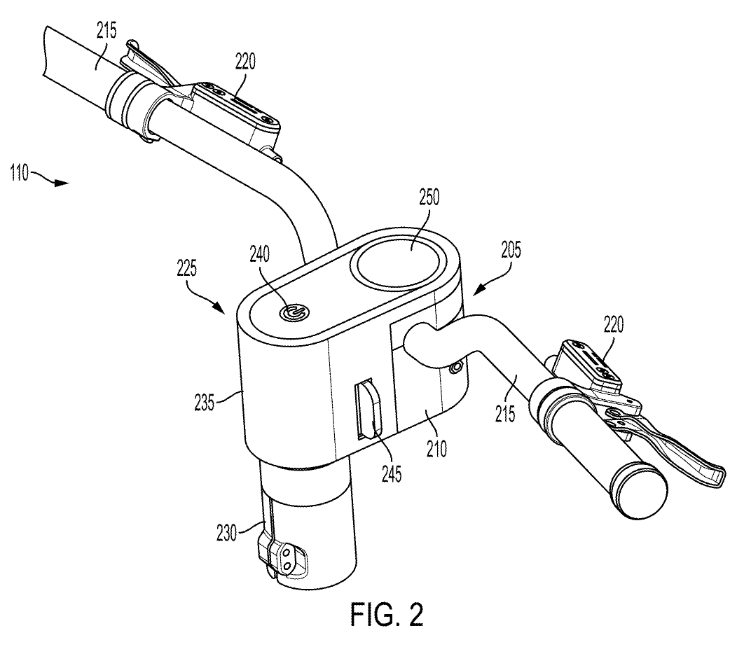

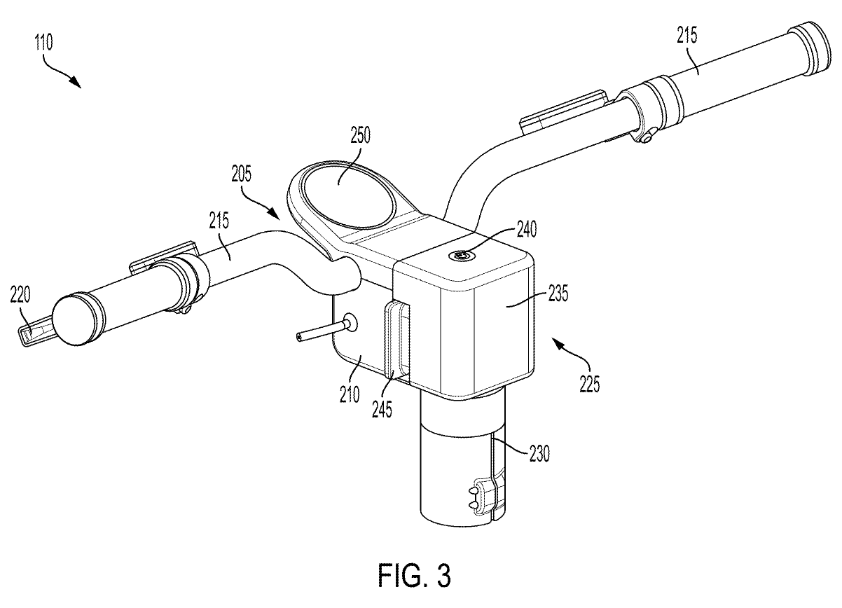

The bike 100 can include an electrical system. The electrical system of the bike 100 can include at least one energy storage device 150. The energy storage device 150 can be any device capable of storing energy (e.g., battery cell, battery, battery pack, capacitor). The energy storage device 150 can be installed or placed within the bike 100. For example, the one or more energy storage devices 150 can be installed on the frame 105 of the bike 100 within one or more of the front portions 135, the middle portion 140, or the rear portion 145 or within a portion of the drive unit 120. The energy storage devices 150 can include or connect with at least one busbar, e.g., a current collector element. For example, the busbar can include electrically conductive material to connect or otherwise electrically couple the energy storage device 150 with other electrical components of the electrical system of the bike 100 to provide electrical power to various systems or components of the bike 100.FIGS. 2 and 3, among others, depict example handlebar assemblies 110. The handlebar assembly 110 can couple a handlebar 205 to a vehicle (e.g., bike 100). The handlebar assembly 110 can include at least one handlebar, shown as handlebar 205. A rider can use the handlebar 205 to control directional movement of a bike 100. The handlebar 205 can include at least one handlebar body 210. The handlebar 205 can include at least one handle 215. The handle 215 can extend from the handlebar body 210. The handlebar 205 can include a plurality of handles 215. For example, the handlebar 205 can include a first handle 215 and a second handle 215. The handle 215 can be a singular curved body that defines first handle portion (e.g., a left handle) and a second handle portion (e.g., a right handle).

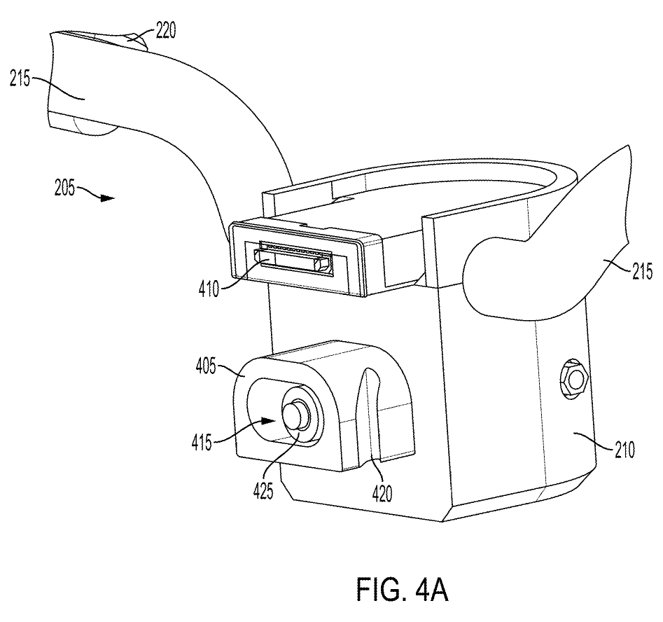

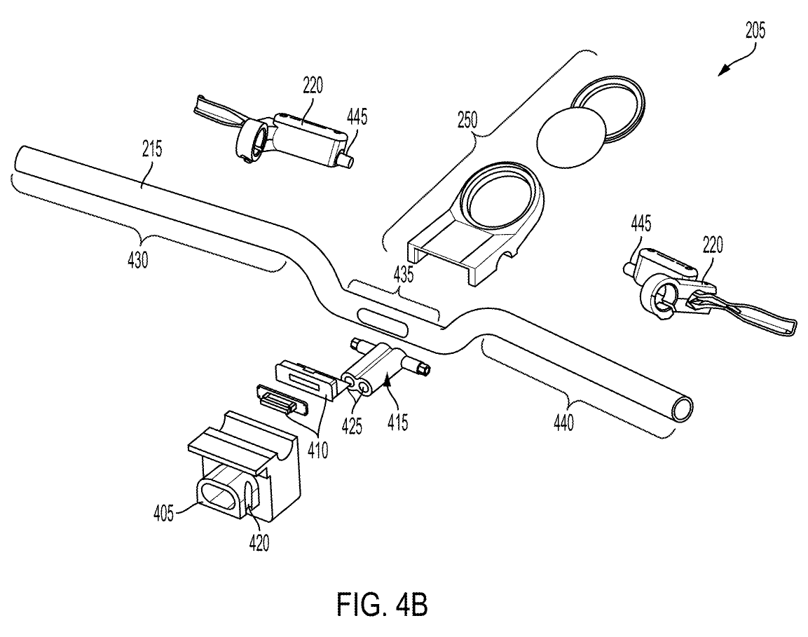

The handlebar 205 can include at least one brake controller 220. The brake controller 220 can couple with the handle 215. The brake controller 220 can facilitate braking of a bike 100. For example, the brake controller 220 can control a brake system 155 of the bike 100. A rider can actuate (e.g., squeeze) a lever of the brake controller 220 to cause the bike 100 to brake and slow down.The brake system 155 allows a user to slow the bike 100 by, for example, applying friction to rims of the wheels 130. The brake system can include a closed hydraulic circuit. For example, the brake system 155 can include at least one brake hose 160 that extends between the brake controller 220 and braking device 165, such as a caliper coupled with a friction brake pad. The brake hose 160 can hold a hydraulic fluid. The brake controller 220 can receive user inputs. The brake controller 220 can control the brake system 155 by causing a change of pressure to be transmitted through the hydraulic fluid within the brake hose 160 to the braking device 165. As shown in FIG. 4B, among others, the brake controller 220 can include a master cylinder 445. The master cylinder 445 of the brake controller 220 can be or include sealed hydraulic chamber containing a piston that is mechanically actuated by the rider squeezing or otherwise actuating the brake controller 220. When the brake controller 220 is actuated, the piston pressurizes hydraulic fluid within the master cylinder 445. Such a change in pressure can be is transmitted through the brake hose 160 to the braking device 165 (e.g., one or more calipers). In this way, the master cylinder 445 converts the rider’s mechanical input via the brake controller 220 into hydraulic force. The brake controller 220 can include electrical sensing elements, such as mechanical switches or hall-effect sensors integrated into the levers of the brake controller 220. The electrical sensing elements can provide redundant detection of brake actuation and potential failure conditions.

The handlebar assembly 110 can include at least one frame unit 225. The handlebar 205 can couple with the frame unit 225. The frame unit 225 can couple with or be integral with the frame 105 of the bike 100. For example, the frame unit 225 can couple with the steering member 121 of the frame 105. The handlebar 205 can couple with the bike 100 via the frame unit 225. The frame unit 225 can include at least one stem connector 230. The stem connector 230 can couple with the frame 105 of the bike 100. Additionally or alternatively, the stem connector 230 can couple with the steering member 121 within the frame 105. The frame unit 225 can include at least one frame unit body 235. The stem connector 230 can be coupled with or integral with the frame unit body 235. The stem connector 230 can extend from the frame unit body 235. The stem connector 230 can define a shape or a form factor that generally corresponds to a shape or a form factor of the frame 105. For example, the stem connector 230 can define a relatively cylindrical shape. The stem connector 230 can at least partially define a shape or a form factor that differs from the shape or the form factor of the frame 105. The frame unit body 235 can define a shape or a form factor that corresponds to the shape or the form factor of the stem connector 230. The frame unit body 235 can at least partially define a shape or a form factor that differs from the shape or the form factor of the stem connector 230.

The frame unit 225 can include at least one interactive element, shown as power button 240. Actuation of the power button 240 can activate various components of the bike 100. For example, a rider can actuate (e.g., push) the power button 240 to turn on electrical components of the bike 100.

The frame unit 225 can include at least one release element 245. The release element 245 can decouple the handlebar 205 from the frame unit 225. For example, actuation of (e.g., pressing) the release element 245 can cause the handlebar 205 to decouple from the frame unit 225.

The handlebar assembly 110 can include at least one user interface 250. The user interface 250 can be any device capable of displaying information to a rider. For example, the user interface 250 can be a screen configured to display a speed of the bike 100, among other information. The user interface 250 can receive input from a rider. For example, the user interface 250 can be a touch screen capable of receiving input from the rider. The user interface 250 can be disposed on the frame unit 225 or the handlebar 205. For example, the user interface 250 can be disposed on or extend from the frame unit body 235. The user interface 250 can be disposed on or extend from the handlebar 205. The user interface 250 can be or include an interface (e.g., a graphical user interface, at least one button, switch, or actuator, or some other interface) to allow a user (e.g., a rider) to affect or influence an operation of the bike 100. For example, a user can make a selection via the user interface 250, and the user interface 250 can provide a signal to the control device 190, where the control device 190 can further control or otherwise affect an operation of the bike 100. The control device 190 can be coupled with the user interface 250, for example, by coupling the handlebar assembly 110 with the frame unit 225. For example, the connection between the electrical handlebar connector 410 and the electrical frame connector 510 can allow for transmission of user inputs from the user interface 250 to the control device 190.

FIGS. 4A and 4B, among others, depict an example handlebar 205. Systems and components of the handlebar 205 can couple with corresponding systems and components of the bike 100. Any conduits (e.g., wiring, tubing) needed to connect such systems and components can be disposed, at least partially, in the handlebar body 210 and travel between the necessary systems and components.

The handlebar 205 can include at least one handlebar connector to couple the handlebar 205, or a component thereof, with the frame unit 225, or a component thereof. For example, the handlebar 205 can include at least one mechanical handlebar connector 405. The mechanical handlebar connector 405 can couple the handlebar body 210 with the frame unit body 235. The mechanical handlebar connector 405 can be a part of, coupled with, extend from, or be disposed in the handlebar body 210. The mechanical handlebar connector 405 can be part of, coupled with, extend from, or disposed in the handle 215. The mechanical handlebar connector 405 can protrude outwardly relative to the handlebar body 210. For example, the mechanical handlebar connector 405 can define a male extension structured to be received by a corresponding female connector defined by the frame unit body 235. The mechanical handlebar connector 405 can include a slot or a recess 420. The recess 420 can receive a coupling device, such as a pin, of the frame unit 225.

The handlebar 205 can include at least one electrical handlebar connector 410. The electrical handlebar connector 410 can couple electrical components of the handlebar 205 with electrical components of the bike 100. The coupling between the electrical handlebar connector 410 and the electrical components of the bike 100 can enable transmission of power or control signal between electronic components of the handlebar 205 (e.g., a throttle control, gear shifting control, among others). The electrical handlebar connector 410 can be a part of, coupled with, extend from, or be disposed in the handlebar body 210. The electrical handlebar connector 410 can include conductive terminals or pins to receive a corresponding connector within the frame unit body 235. The electrical handlebar connector 410 can connectors to receive conductive terminals or pins positioned on or within the frame unit body 235.

The handlebar 205 can include at least one hydraulically actuated brake handlebar connector 415. The hydraulically actuated brake handlebar connector 415 can couple the brake controller 220 of the handlebar 205 with brake elements of the bike 100. The hydraulically actuated brake handlebar connector 415 can include a first hydraulic interconnect 425 that actuates to transmit user inputs from the brake controller 220 to the brake system 155 of the bike 100. For example, the bike 100 can have a hydraulic brake system. The hydraulically actuated brake handlebar connector 415 can couple the brake controller 220 with the brake system 155 such that the brake controller 220 can control the hydraulic brake system. For example, a user input via the brake controller 220 can cause the hydraulically actuated brake handlebar connector 415 actuate. The hydraulically actuated brake handlebar connector 415 can be a part of, coupled with, extend from, or be disposed in the handlebar body 210. For example, the hydraulically actuated brake handlebar connector 415 can be positioned within the mechanical handlebar connector 405, as shown in FIG. 4A and 4B, among others. The first hydraulic interconnect 425 can be or include at least one piston cylinder. For example, the first hydraulic interconnect 425 can be or include a first piston cylinder and a second piston cylinder. The first piston cylinder can couple with a first brake controller 220 (e.g., a left brake controller 220). For example, the first piston cylinder of the first hydraulic interconnect 425 can couple with the master cylinder 445 of the first brake controller 220 via a brake hose 160. In this way, when a user actuates the first brake controller 220, the master cylinder 445 of the first brake controller 220 can cause the first piston cylinder of the first hydraulic interconnect 425 to actuate (e.g., such that the first piston cylinder of the first hydraulic interconnect 425 is a slave cylinder to the master cylinder 445 of the first brake controller 220). The second piston cylinder can couple with a second brake controller 220 (e.g., a right brake controller 220). For example, the second piston cylinder of the first hydraulic interconnect 425 can couple with the master cylinder 445 of the second brake controller 220 via a brake hose 160. In this way, when a user actuates the second brake controller 220, the master cylinder 445 of the second brake controller 220 can cause the second piston cylinder of the first hydraulic interconnect 425 to actuate (e.g., such that the second piston cylinder of the first hydraulic interconnect 425 is a slave cylinder to the master cylinder 445 of the first brake controller 220).

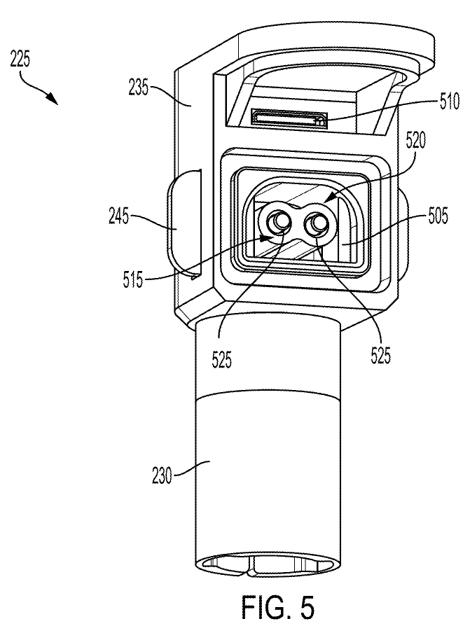

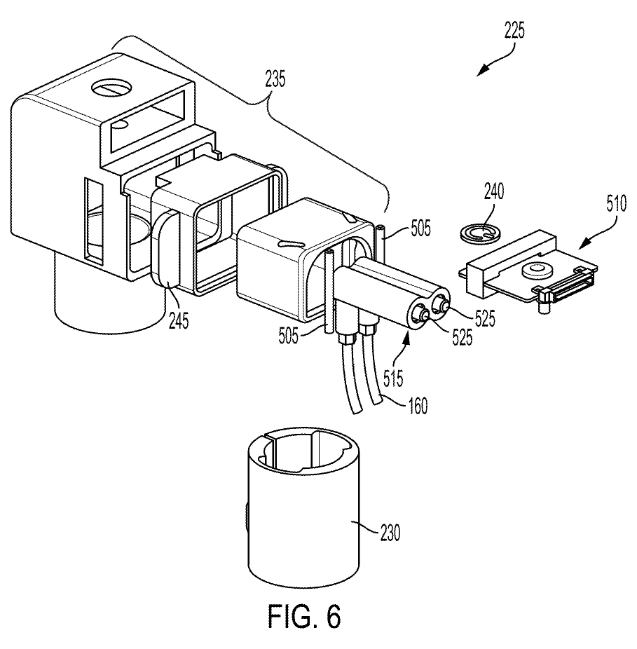

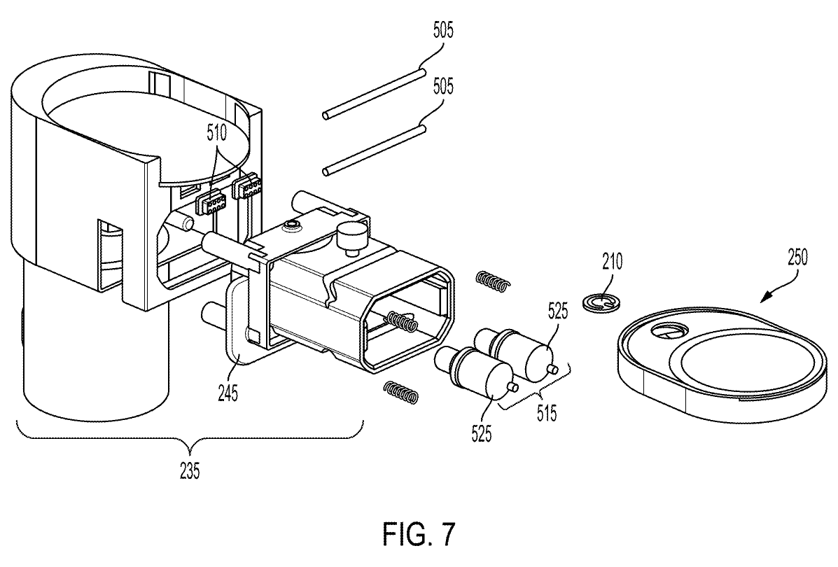

FIGS. 5-7, among others, depict an example frame unit 225. Systems and components of the bike 100 can couple with corresponding systems and components of the handlebar 205. Any conduits (e.g., wiring, tubing) needed to connect such systems and components can be disposed, at least partially, in the frame unit body 235 and travel through the stem connector 230 and other structural members of the frame 105 between the necessary systems and components.

The frame unit 225 can include at least one frame connector to couple the frame unit 225, or a portion thereof, with the handlebar 205, or a portion thereof. The frame unit 225 can include a female connector, shown as a cavity 520, to receive the mechanical handlebar connector 405. The frame unit 225 can include at least one mechanical frame connector 505. The mechanical frame connector 505 can couple with the mechanical handlebar connector 405 to couple the frame unit body 235 with the handlebar body 210. The mechanical frame connector 505 can include at least one biasing member. The biasing member can be or include a spring-loaded pin. The mechanical frame connector 505 can couple with the release element 245. The release element 245 can be operated (e.g., pulled, pushed, or otherwise actuated by a user) to move the mechanical frame connector 505 between a retention position and a release position. In the retention position, the mechanical frame connector 505 can engage with (e.g., be at least partially positioned within) the corresponding slot or recess 420 in the mechanical handlebar connector 405 to couple the handlebar 205 with the frame unit 225. In the release position, the mechanical frame connector 505 can be spaced apart from the recess 420 in the mechanical handlebar connector 405 such that the mechanical handlebar connector 405 can be moved away from the cavity 520 to decouple the handlebar 205 from the frame unit 225. The mechanical frame connector 505 can be a part of, coupled with, extend from, or be disposed in the frame unit body 235. For example, the mechanical frame connector 505 can be positioned within the cavity 520.

The frame unit 225 can include at least one electrical frame connector 510. The electrical frame connector 510 can couple electrical components of the bike 100 with electrical components of the handlebar 205. For example, the electrical frame connector 510 can couple with the electrical handlebar connector 410 to electrically couple the handlebar 205 with the bike 100. The electrical frame connector 510 can be a part of, coupled with, extend from, or be disposed in the frame unit body 235.

The frame unit 225 can include at least one brake frame connector 515. The brake frame connector 515 can couple brake elements of the bike 100 with the brake controller 220 of the handlebar 205. The brake frame connector 515 can couple with the hydraulically actuated brake handlebar connector 415. The brake frame connector 515 can be a part of, coupled with, extend from, or be disposed in the frame unit body 235. For example, the brake frame connector 515 can be positioned within the cavity 520, as shown in FIG. 5, among others. The second hydraulic interconnect 525 can couple with a brake hose 160 of the brake system 155. In this way, actuation of the second hydraulic interconnect 525 can transmit a change in hydraulic pressure through the brake hose 160 to a braking device 165. The hydraulically actuated brake handlebar connector 415 can include a second hydraulic interconnect 525 to that actuates based on actuation of the first hydraulic interconnect 425. The second hydraulic interconnect 525 can be or include at least one piston cylinder. For example, the second hydraulic interconnect 525 can include a first piston cylinder and a second piston cylinder. The first piston cylinder of the second hydraulic interconnect 525 can couple with a piston cylinder of a first braking device 165 via the brake hose 160, such that the first piston cylinder of the second hydraulic interconnect 525 serves as a master cylinder to the piston cylinder of the first braking device 165. The first piston cylinder of the second hydraulic interconnect 525 is referred to herein as the first master cylinder of the second hydraulic interconnect 525.The second piston cylinder of the second hydraulic interconnect 525 can couple with a piston cylinder of a second braking device 165 via the brake hose 160, such that the second piston cylinder of the second hydraulic interconnect 525 serves as a master cylinder to the piston cylinder of the second braking device 165. The second piston cylinder of the second hydraulic interconnect 525 is referred to herein as the second master cylinder of the second hydraulic interconnect 525.

The first master cylinder of the second hydraulic interconnect 525 can interface with the first piston cylinder of the first hydraulic interconnect 425 upon coupling the handlebar 205 with the frame unit 225. For example, actuation of the first piston cylinder of the first hydraulic interconnect 425 responsive to a user squeezing or otherwise actuating the first brake controller 220 can cause the first piston cylinder of the first hydraulic interconnect 425 to actuate the first master cylinder of the second hydraulic interconnect 525 (e.g., by the piston of the first piston cylinder of the first hydraulic interconnect 425 moving outward to exert force on the master cylinder of the second hydraulic interconnect 525, thereby causing the second hydraulic interconnect 525 to actuate). Actuation of the first master cylinder of the second hydraulic interconnect 525 transmits a change in pressure through the hydraulic fluid within the brake hose 160 to actuate the first braking device 165.

The second master cylinder of the second hydraulic interconnect 525 can interface with the second piston cylinder of the first hydraulic interconnect 425 upon coupling the handlebar 205 with the frame unit 225. For example, actuation of the first piston cylinder of the first hydraulic interconnect 425 responsive to a user squeezing or otherwise actuating the first brake controller 220 can cause the first piston cylinder of the first hydraulic interconnect 425 to actuate the first master cylinder of the second hydraulic interconnect 525 (e.g., by the piston of the first piston cylinder of the first hydraulic interconnect 425 moving outward to exert force on the master cylinder of the second hydraulic interconnect 525, thereby causing the second hydraulic interconnect 525 to actuate). Actuation of the second master cylinder of the second hydraulic interconnect 525 transmits a change in pressure through the hydraulic fluid within the brake hose 160 to actuate the second braking device 165.

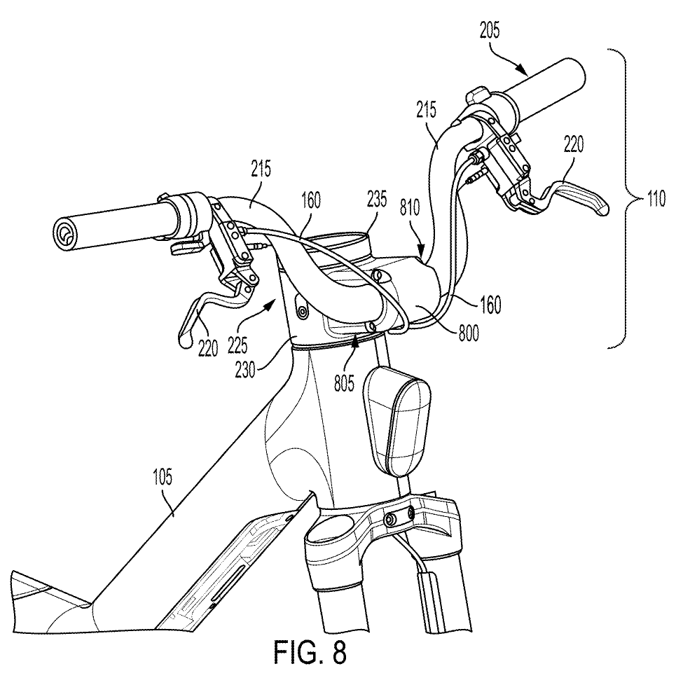

An electrical connection can be provided to transmit brake actuation signals from the brake controllers 220 to onboard electronic brake assistance systems. For example, the electrical brake actuation signals can actuate an electromechanical brake system, such as a hydraulic pump. The electromechanical brake system can generate and modulate hydraulic pressure for the braking devices 165 based on the brake actuation signals from the brake controller 220. Additionally or alternatively, the electrical brake actuation signals can drive a direct electromechanical brake caliper of the braking device 165. In some examples, brake hoses 160 of the handlebar 205 are mechanically coupled with the brake hoses 160 of the frame 105 of the 100. As shown in FIGS. 8-13, among others, brake hoses 160 may be routed from the braking device 165 of the bike 100 through the frame 105 and outlet from the stem of the frame 105 for connection with the brake controller 220 of the handlebar 205. In this way, a user may mechanically connect and disconnect the brake hose 160 with the brake controller 220 when removing or installing a handlebar 205.

At least one of the mechanical frame connectors 505, electrical frame connector 510, and the brake frame connector 515 can be coupled with or associated with the release element 245. For example, actuation of the release element 245 can cause at least one of the mechanical frame connectors 505, electrical frame connector 510, or the brake frame connector 515 to disconnect from the corresponding mechanical handlebar connector 405, electrical handlebar connector 410, and the hydraulically actuated brake handlebar connector 415. For example, the mechanical frame connector 505, or a portion thereof, can move between a retention position and a release position. Actuation of the release element 245 can cause the mechanical frame connector 505 to move from the retention position to the release position to allow the handlebar 205 to disconnect from and move away from the frame unit 225.

As an illustrative example, the handlebar 205 can include a mechanical handlebar connector 405. The frame unit 225 can include a mechanical frame connector 505 that corresponds with the mechanical handlebar connector 405. The mechanical frame connector 505, or a portion thereof, can move between a retention position and a release position. The mechanical frame connector 505 can couple with the mechanical handlebar connector 405 to couple the handlebar 205 with the frame unit 225. The frame unit 225 can include the release element 245. The release element 245 can decouple the handlebar 205 from the frame unit 225. For example, actuation of the release element 245 can actuate the mechanical frame connector 505, or portion thereof, from the retention position to the release position.

All of the mechanical frame connector 505, electrical frame connector 510, and the brake frame connector 515 can be coupled with or associated with the release element 245. For example, actuation of the release element 245 can cause all of the mechanical frame connector 505, electrical frame connector 510, and the brake frame connector 515 to disconnect from the corresponding mechanical handlebar connector 405, electrical handlebar connector 410, and the hydraulically actuated brake handlebar connector 415. The single release element 245 facilitates easy disconnection of the handlebar 205 from the frame unit 225 with a single release motion from a rider via the release element 245. Beneficially, such a single release motion does not require the user to use tools to connect and disconnect the handlebar 205 form the frame unit 225.

The frame unit 225 can include an anchor. For example, the mechanical frame connector 505 can be or include the anchor. Examples of the anchor are described, for example, in U.S. Patent Application No. 19/206,745, filed May 13, 2025, which is hereby incorporated by reference herein in its entirety. The anchor can be any element or object capable of moving between positions. For example, the anchor can be molded from any material (e.g., plastic) and can have any shape (e.g., a c-shape). The anchor can be at least partially disposed within the frame unit 225. The anchor can be movable within the frame unit 225. For example, an actuator can move the anchor between a first position (e.g., unlocked position) and a second position (e.g., locked position). The actuator can move the anchor from the first position to the second position in response to a sensor detecting the handlebar 205 or the user interface 250, or another user device communicatively coupled with the control device 190, receiving a user input. The actuator can move the anchor by pulling or pushing the anchor. For example, the actuator can cause the anchor to slide relative to the frame unit 225.

In the first position, the anchor can be fully disposed within the frame unit 225. In the second position, the anchor can extend at least partially from the frame unit 225 into a recess within a component of the handlebar 205, such as the handlebar body 210 or the handle 215, such that the anchor applies a force to the handlebar 205. The force applied by the anchor to the component of the handlebar 205 can prevent the handlebar 205 from being decoupled from the frame unit 225. The handlebar 205 can be decoupled from the frame unit 225 after the actuator moves the anchor from the second position to the first position in response to the user interface 250, or another user device communicatively coupled with the control device 190, receiving a user input.

The frame unit 225 can include a mechanical frame connector 505, an electrical frame connector 510, and a brake frame connector 515 disposed in the frame body. The frame unit 225 can include a release element 245 coupled with the mechanical frame connector 505, electrical frame connector 510, and the brake frame connector 515. The handlebar 205 can include a mechanical handlebar connector 405 to couple with the mechanical frame connector 505, an electrical handlebar connector 410 to couple with the electrical frame connector 510, and a brake handlebar connector 415 to couple with the brake frame connector 515. The release element 245 can disconnect the mechanical handlebar connector 405 from the mechanical frame connector 505, the electrical handlebar connector 410 from the electrical frame connector 510, and the hydraulically actuated brake handlebar connector 415 from the brake frame connector 515. For example, a single actuation of the release element 245 can disconnect each of the frame connectors from the corresponding handlebar connectors such that the handlebar 205 can be released from and move away from the frame unit body 235.

To assemble the handlebar assembly 110 and couple the handlebar 205 with the frame 105 of the bike 100 can be a single step, toolless, process. For example, assembling the handlebar assembly 110 can include inserting the mechanical handlebar connector 405 into the cavity 520 of the frame unit body 235. Such insertion may actuate the mechanical frame connector 505 of the frame unit 225 until the recess 420 of the mechanical handlebar connector 405 aligns with the mechanical frame connector 505. The mechanical frame connector 505 can release from the actuated portion to engage with the recess 420. For example, the mechanical frame connector 505 can extend into the recess 420 to mechanically couple the mechanical handlebar connector 405 of the handlebar 205 with the mechanical frame connector 505 of the frame unit 225.

Upon inserting the mechanical handlebar connector 405 of the handlebar 205 into the cavity 520 within the frame unit body 235 of the frame unit 225, the electrical handlebar connector 410 of the handlebar 205 can be received by or receive the electrical frame connector 510 of the frame unit 225. In this way, upon engaging the mechanical frame connector 505 of the frame unit 225 with the recess 420 defined in the mechanical handlebar connector 405 of the handlebar 205, the electrical handlebar connector 410 couples with the electrical frame connector 510 to electrically couple the handlebar 205 with the frame unit 225.

Upon inserting the mechanical handlebar connector 405 of the handlebar 205 into the cavity 520 within the frame unit body 235 of the frame unit 225, the hydraulically actuated brake handlebar connector 415 of the handlebar 205 can couple with the brake frame connector 515. For example, the piston cylinders of the first hydraulic interconnect 425 can abut or otherwise interface with the master cylinders of the second hydraulic interconnect 525. In this way, upon engaging the mechanical frame connector 505 of the frame unit 225 with the recess 420 defined in the mechanical handlebar connector 405 of the handlebar 205, the hydraulically actuated brake handlebar connector 415 couples with the brake frame connector 515 to allow brake inputs from the user made via the brake controller 220 on the handlebar 205 to be transmitted to the brake system 155 of the bike 100. In this way, the engagement of the mechanical frame connector 505 of the frame unit 225 with the recess 420 on the mechanical handlebar connector 405 of the handlebar 205 serves to provide mechanical, electrical, and hydraulic connections between the handlebar 205 and the frame unit 225.

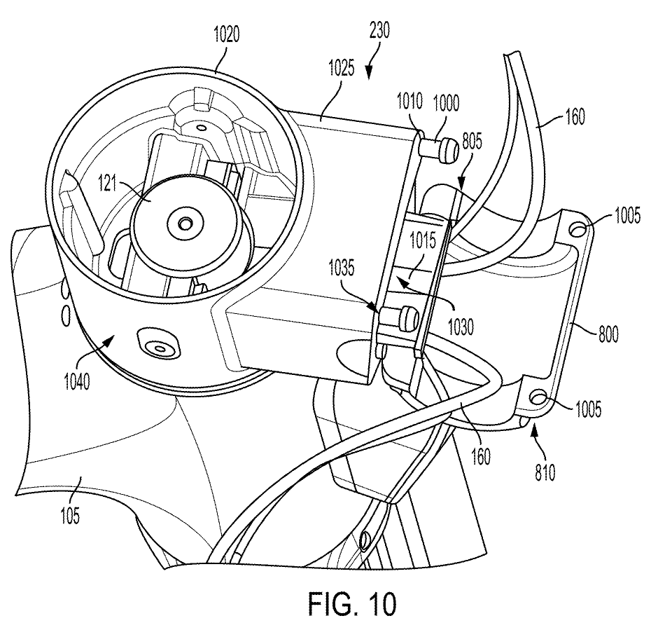

FIGS. 8-13 depict the handlebar assembly 110 in various stages of assembly. The frame unit 225 can include a mechanical frame connector 505 structured as a face plate 800. The face plate 800 can define a curved body or a body having a form factor that corresponds to a cross-sectional shape of the handle 215. For example, if the handle 215 defines a circular cross-section, then the face plate 800 can define semi-circular curved body. The face plate 800 is structured to extend around at least a portion of a perimeter or circumference of the handle 215 to hold the handle 215 in place. The face plate 800 can include a release element 245 structured as fasteners 1000. The fasteners 1000 can be installed (e.g., by threading into a fastener opening) or removed to allow the face plate 800 to move between a retention position, as shown in FIG. 8, and a release position, as shown in FIG. 10. The face plate 800 can include a hinge portion 805. The hinge portion 805 rotatably couples the face plate 800 with a portion of the frame unit 225. The face plate 800 can rotate about the hinge portion to move between the retention position, as shown in FIG. 8, and the release portion, as shown in FIG. 10. The face plate 800 can include a mating portion 810. The mating portion 810 is structured to receive or engage with the release element 245, such as the fasteners 1000, to hold the face plate 800 in the retention position. The mating portion 810 may be positioned on an opposite end of the face plate 800 relative to the hinge portion 805 or an adjacent side relative to the hinge portion 805. The mating portion 810 can include openings 1005 to receive the fasteners 1000. In this way, the fasteners 1000 can extend through the openings 1005 and couple with a portion of the frame unit 225 to hold the face plate 800 in the retention position.

The frame unit 225 can include the stem connector 230. The stem connector 230 can couple with the frame 105 and with the steering member 121. The stem connector 230 can include at least one channel 1200 to receive the brake hose 160 of the brake system 155. For example, the brake hose 160 can be routed through the frame 105 and into the stem connector 230. The brake hose 160 can exit the stem connector 230 through the channel 1200. The user may couple the brake hose 160 with the brake controller 220 positioned on the handlebar 205.

The stem connector 230 can include a first portion 1020 to couple with the frame 105. The first portion 1020 can define a shape or a form factor that generally corresponds to a shape or a form factor of the frame 105. For example, the first portion 1020 can define a relatively cylindrical shape. The first portion 1020 can couple with the frame 105 such that an end of the steering member 121 extends into an interior volume of the first portion 1020. The stem connector 230 can include a second portion 1025 that extends away from first portion 1020. The second portion 1025 can include a top wall, a bottom wall, and a pair of side walls extending between the top wall and the bottom wall. The walls of the second portion 1025 can extend radially away from a side surface 1040 of the first portion 1020. The space between the walls of the second portion 1025 defines an opening 1030. The opening 1030 can receive a portion of the handlebar 205. For example, the opening 1030 can receive a handlebar connector 1405 of the handlebar 205.

An outer edge 1010 of the second portion 1025 can include a first coupling interface 1015. The hinge portion 805 of the face plate 800 can couple with the hinge portion 805. The first coupling interface 1015 can include a channel or channels to receive shafts of the hinge portion 805. The shafts of the hinge portion 805 can rotate within the channels of the first coupling interface 1015 to allow the face plate 800 to rotate about an axis extending between the hinge portion 805 and the first coupling interface 1015. The outer edge 1010 of the second portion 1025 can include a second coupling interface 1035. The second coupling interface 1035 can be positioned on an opposite side of the outer edge 1010 relative to the first coupling interface 1015. The second coupling interface 1035 can be or include openings to receive the fasteners 1000. For example, the second coupling interface 1035 can include threaded openings to receive fasteners 1000 structured as screws. The second coupling interface 1035 can couple with the mating portion 810 of the face plate 800. For example, the fasteners 1000 can extend through the openings 1005 of the mating portion 810 and into the openings of the second coupling interface 1035 to hold the face plate 800 in the retention position.

The frame unit 225 can include an electrical frame connector 1410. The electrical frame connector 1410 may be the same as or substantially similar to the electrical frame connector 510. The electrical frame connector 1410 can couple with the electrical system of the bike 100. For example, the energy storage device 150 of the bike 100 and the electrical frame connector 1410 can couple by wired connection. In this way, the electrical frame connector 1410 can receive and transmit electrical power. The electrical frame connector 1410 can include at least one pin. The pin of the electrical frame connector 1410 can be received by a corresponding connector, such that the pin transmits electrical power from the energy storage device 150 to the corresponding connector. The frame unit 225 can include the frame unit body 235. The frame unit body 235 can removably couple with the stem connector 230. The frame unit body 235 can define a shape or a form factor that corresponds to the shape or the form factor of the stem connector 230. The frame unit body 235 can at least partially define a shape or a form factor that differs from the shape or the form factor of the stem connector 230. The frame unit body 235 can include the electrical frame connector 1410. For example, the electrical frame connector 1410 can be positioned on a bottom side of the frame unit body 235. The bottom side of the frame unit body 235 can engage with or be at least partially received by the first portion 1020 of the stem connector 230. The frame unit body 235 can couple with the first portion 1020 such that the electrical frame connector 1410 is positioned within an interior volume of the stem connector 230.

The frame unit body 235 can include a user interface 250. As noted above, the user interface 250 can be any device capable of displaying information to a rider. For example, the user interface 250 can be a screen configured to display a speed of the bike 100, among other information. The user interface 250 can receive input from a rider. For example, the user interface 250 can be a touch screen capable of receiving input from the rider. The user interface 250 can couple with the electrical frame connector 1410 to receive electrical power. For example, the electrical frame connector 1410 and the user interface 250 can couple via a wired connection.

The handlebar 205 can couple with the frame unit 225. For example, the handle 215 can be positioned between the second portion 1025 of the stem connector 230 and the curved body of the face plate 800. In the retention position, the face plate 800 can extend around at least a portion of the circumference or perimeter of the handle 215 (e.g., 30-50% of the circumference or perimeter, 40-60% of the circumference or perimeter, or >50% of the of the circumference or perimeter). In the retention position, the outer edge 1010 of the second portion 1025 of the stem connector 230 can extend around at least a portion of the remaining circumference or perimeter of the handle 215 (e.g., a portion of the circumference or perimeter that the face plate 800 does not extend around). The face plate 800 and the stem connector 230 can cooperatively form a mechanical coupling between the frame unit 225 and the handlebar 205. In the retention position, the handle 215 can extend from mechanical frame connector 505 structured as the face plate 800. For example, the face plate 800 and the stem connector 230 can extend around at least a portion of the circumference or perimeter of a central portion of the handle 215. A first handle portion 430 (e.g., a left handle) and a second handle portion 440 (e.g., a right handle) can extend from the central handle portion 435.

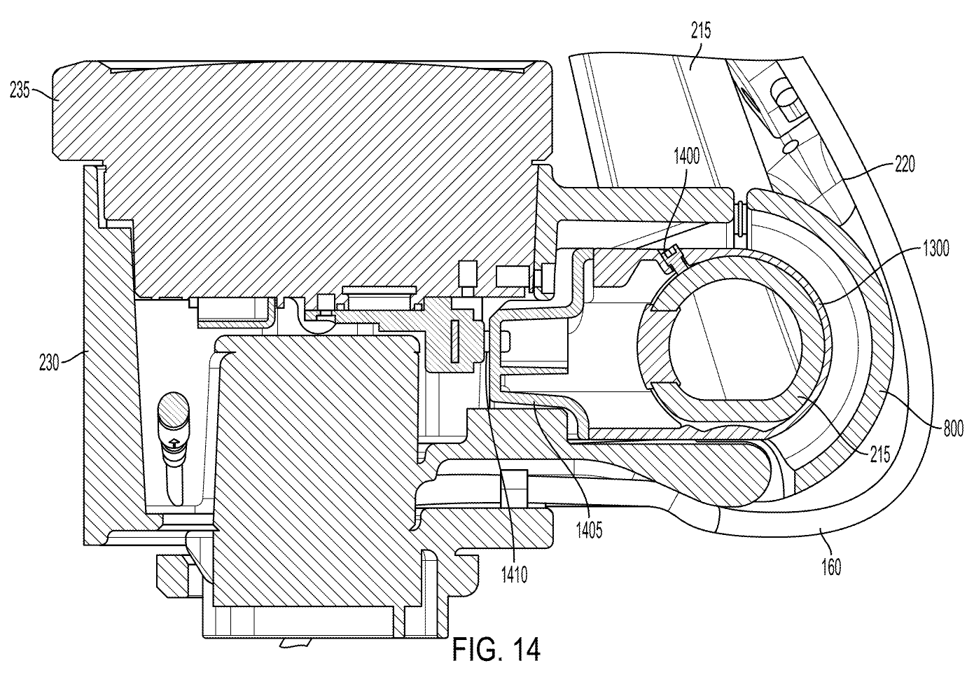

The handlebar 205 can include a handlebar connector 1405. The handlebar connector 1405 can include a first side 1510 and a second side 1505. The first side 1510 can couple with the handle 215. For example, the first side 1510 of the handlebar connector 1405 can couple with the handle 215 such that the first side 1510 of the handlebar connector 1405 receives at least one cable 1500 from the handle 215. The cable 1500 may be an electrical cable that transmits electrical power or signals to and from components of the handlebar 205. The handlebar connector 1405 can be structured as an electrical connector. For example, the handlebar connector 1405 can include at least one connector opening 1600. The at least one connector opening can be positioned on the second side 1505 of the electrical frame connector 1410. The connector opening 1600 can receive a portion of the electrical frame connector 1410. For example, as shown in FIG. 14, among others, the connector opening 1600 can receive pins of the electrical frame connector 1410 such that the pins of the electrical frame connector 1410 extend at least partially into the interior volume of the handlebar connector 1405. Upon coupling the handlebar connector 1405 with the electrical frame connector 1410, the handlebar 205 can be coupled with the electrical system of the bike 100. For example, coupling the handlebar connector 1405 with the electrical frame connector 1410 can allow electrical components of the handlebar 205 to receive electrical power from the energy storage device 150 of the bike 100.

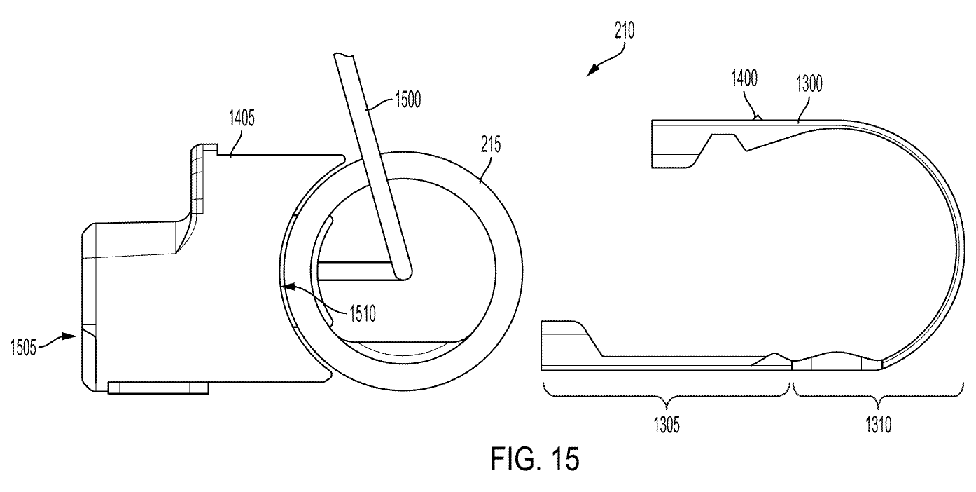

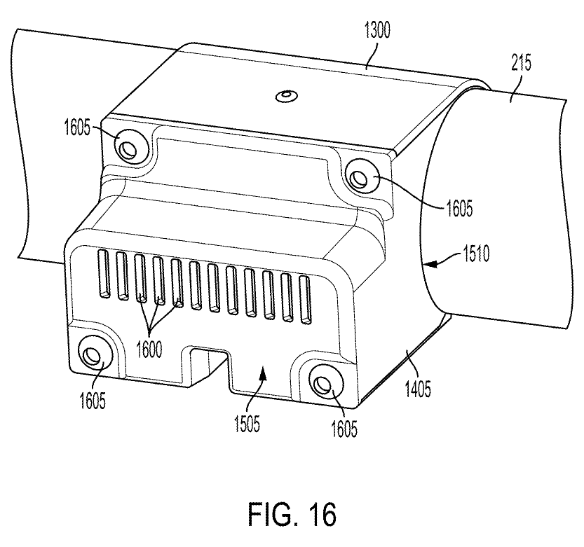

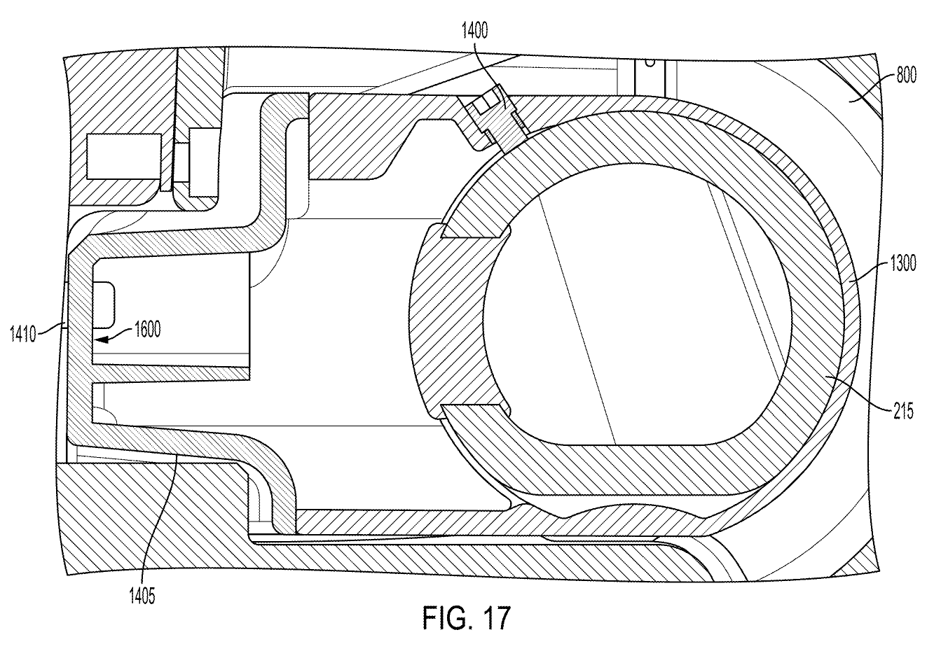

As shown in FIGS. 14-17, among others, the handlebar 205 can include an extrusion member 1300. The extrusion member 1300 can extend around a portion of the handle 215. For example, the extrusion member 1300 can extend at least partially around the circumference or perimeter of the handle 215 (e.g., 30-50% of the circumference or perimeter, 40-60% of the circumference or perimeter, or >50% of the of the circumference or perimeter). The extrusion member 1300 can extend at least partially around the handlebar connector 1405. For example, the extrusion member 1300 can extend at least partially across a top surface and a bottom surface of the handlebar connector 1405. The extrusion member 1300 can include a first portion 1310 and a second portion 1305. The first portion 1310 can define a curved shape or a form factor that corresponds to a cross-sectional shape of the handle 215. For example, if the handle 215 defines a circular cross-section, then the first portion 1310 of the extrusion member 1300 can define semi-circular curved body. The second portion 1305 of the extrusion member 1300 can define a relatively straight shape or a form factor that corresponds to a cross-sectional shape of the handlebar connector 1405. The extrusion member 1300 can mechanically couple the handlebar connector 1405 with the handle 215. The handle 215 can be moveable (e.g., rotatable, translatable) in the space between the handlebar connector 1405 and the extrusion member 1300. The extrusion member 1300 can couple with the handlebar connector 1405 via one or more fasteners 1605 (e.g., bolts, screws, adhesive, a combination thereof).

A set screw 1400 can extend through the extrusion member 1300 to engage with the handle 215. The set screw 1400 can be moveable between a disengaged position and an engaged position. For example, the set screw 1400 can be tightened to fix the handle 215 in position (e.g., an engaged position) or loosened to allow the handle 215 to move (e.g., a disengaged position). For example, a user may loosen the set screw 1400 and rotate the handle 215 to adjust an angle of the handlebar 205. The set screw 1400 can extend through the extrusion member 1300 at an interface between the first portion 1310 and the second portion 1305. At least a portion of the set screw 1400 can be supported by the first side 1510 of the handlebar connector 1405.

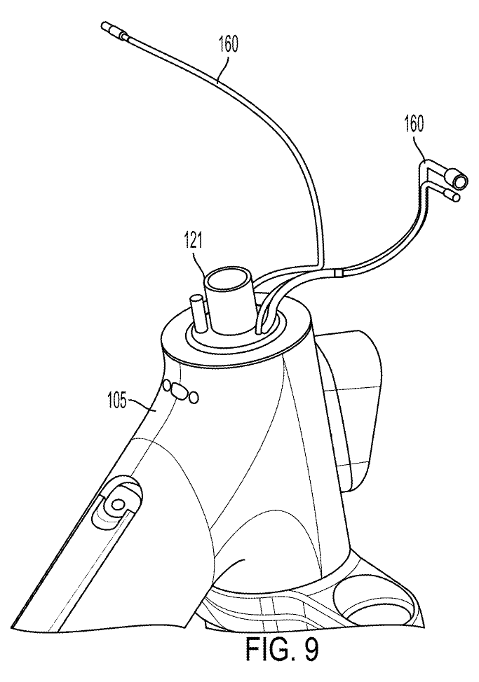

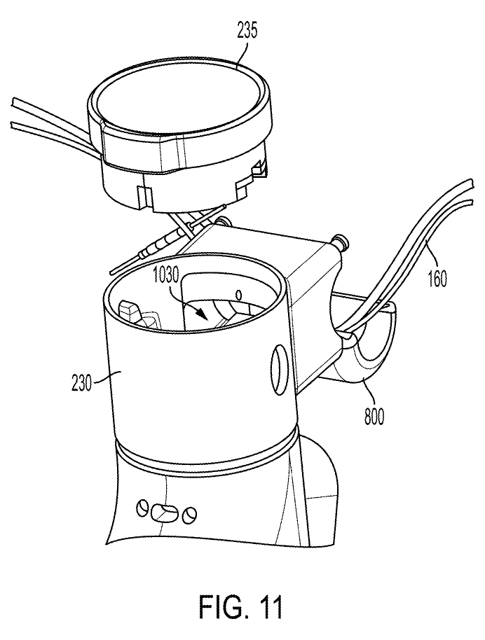

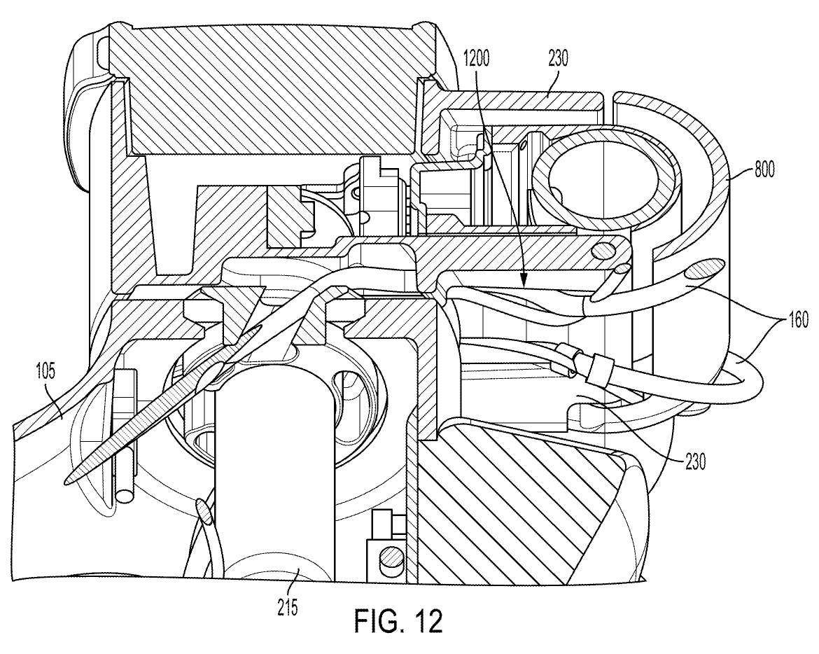

To assemble and couple the handlebar 205 with the frame 105 of the bike 100 can be a multi-step process. For example, a first step can include coupling stem connector 230 with the frame 105 (e.g., as shown between FIGS. 9 and 10). A second step can include routing the brake hose 160 from the frame 105 through the stem connector 230. For example, the brake hose 160 can be routed through the at least one channel 1200 in the stem connector 230 (e.g., as shown in FIGS. 10 and 12). A third step can include coupling the frame unit body 235 with the stem connector 230 (e.g., as shown in FIGS. 11-13). For example, the frame unit body 235 can be aligned with the first portion 1020 of the stem connector 230, then connected with the stem connector 230 such that at least a portion of the frame unit body 235 is positioned within the interior volume of the stem connector 230. The frame unit body 235 can couple with the stem connector 230 by a fastener, for example.

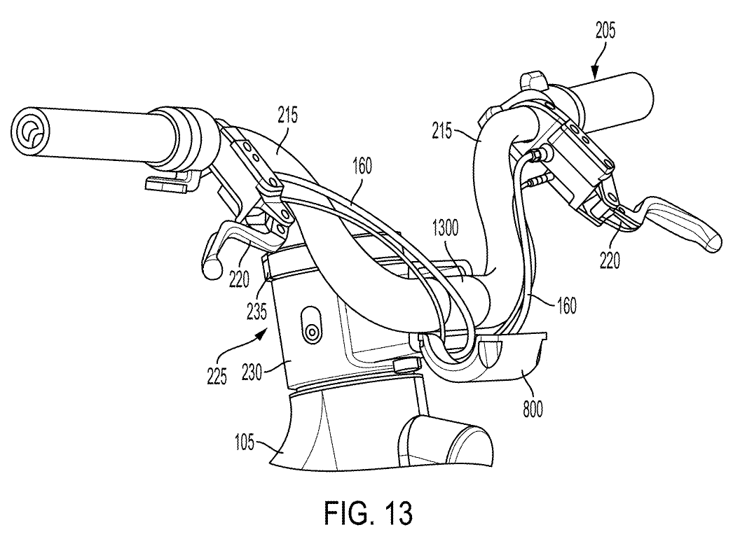

A fourth step can include aligning the handlebar connector 1405 with the electrical frame connector 1410 and coupling the handlebar connector 1405 with the electrical frame connector 1410 while the face plate 800 is in the release position (e.g., as shown in FIG. 13). A fifth step can include moving the face plate 800 from the release position (e.g., as shown in FIG. 13) to the retention position (e.g., as shown in FIG. 8). For example, the face plate 800 can rotate about the hinge portion 805 to move between the release position and the retention position. A fifth step can include installing the fasteners 1000 such that the fasteners 1000 extend through the openings 1005 in the mating portion 810 of the face plate 800 to engage with the second coupling interface 1035. The fasteners 1000 can serve as a release element 245, in that the fasteners 1000 can be engaged to hold the face plate 800 in the retention position or disengaged to allow the face plate 800 to move to the release position. A sixth step can include coupling the brake hose 160 with the brake controller 220 positioned on the handle 215 of the handlebar 205.

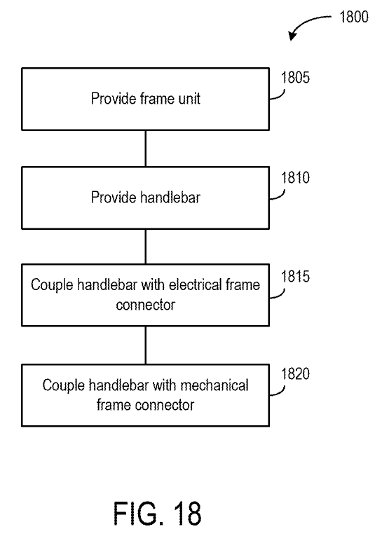

FIG. 18, among others, depict a flow diagram of an example method 1800 of producing the handlebar assembly 110. The method 1800 can include at least one act of providing the frame unit 225 (e.g., act 1805). Providing the frame unit 225 can include manufacturing or assembling the frame unit 225 in whole, or in part. Providing the frame unit 225 can include providing the stem connector 230. Providing the frame unit 225 can include providing the frame unit body 235.

The method 1800 can include at least one act of providing the handlebar 205 (e.g., act 1810). Providing the handlebar 205 can include manufacturing the handlebar 205 in whole, or in part. Providing the handlebar 205 can include providing the handle 215. Providing the handlebar 205 can include providing the handlebar body 210 or the handlebar connector 1405.

The method 1800 can include at least one act of coupling the handlebar 205 with an electrical frame connector, such as the electrical frame connector 510 or the electrical frame connector 1410 (e.g., act 1815). Coupling the handlebar 205 with the electrical frame connector 1410 can include aligning the handlebar connector 1405 with the electrical frame connector 1410 and coupling the handlebar connector 1405 with the electrical frame connector 1410 while the face plate 800 is in the release position (e.g., as shown in FIG. 13). Upon coupling the handlebar connector 1405 with the electrical frame connector 1410, at least one pin of the electrical frame connector 1410 can extend into the connector opening 1600 of the handlebar connector 1405. Coupling the handlebar 205 with the electrical frame connector 510 can include aligning the electrical handlebar connector 410 and the electrical frame connector 510 such that pins of the electrical handlebar connector 410 or the electrical frame connector 510 extend into a corresponding connector of the electrical handlebar connector 410 or the electrical frame connector 510.

The method 1800 can include at least one act of coupling the handlebar 205 with a mechanical frame connector (e.g., act 1820), such as the mechanical frame connector 505 or the face plate 800. Coupling the handlebar 205 with the mechanical frame connector 505 can include inserting the mechanical handlebar connector 405 into the cavity 520. Coupling the handlebar 205 with the mechanical frame connector 505 can include actuating the release element 245 to a release position while the mechanical handlebar connector 405 is being inserted into the cavity 520. Coupling the handlebar 205 with the mechanical frame connector 505 can include actuating the release element 245 to a retention position, such that the mechanical frame connector 505 engages with the recess 420 of the mechanical handlebar connector 405. For example, a pin of the mechanical frame connector 505 can extend at least partially into the recess 420 if the mechanical handlebar connector 405 to hold the handlebar 205 in place.

Coupling the handlebar 205 with the mechanical frame connector 505 can include moving the face plate 800 from the release position (e.g., as shown in FIG. 13) to the retention position (e.g., as shown in FIG. 8). For example, the face plate 800 can rotate about the hinge portion 805 to move between the release position and the retention position. Coupling the handlebar 205 with the mechanical frame connector 505 can include installing the fasteners 1000 such that the fasteners 1000 extend through the openings 1005 in the mating portion 810 of the face plate 800 to engage with the second coupling interface 1035. The fasteners 1000 can serve as a release element 245, in that the fasteners 1000 can be engaged to hold the face plate 800 in the retention position or disengaged to allow the face plate 800 to move to the release position.

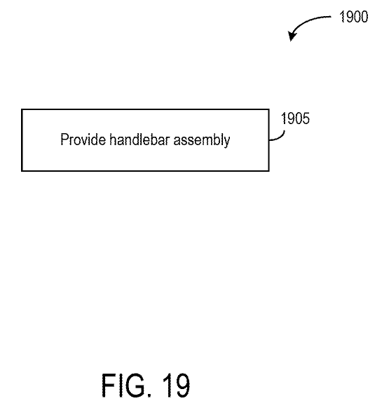

FIG. 19, among others, depict a flow diagram of an example method 1900. The method 1900 can include at least one act of providing a handlebar assembly 110 (e.g., act 1905). Providing the handlebar assembly 110 can include manufacturing or assembling the handlebar assembly 110 in whole or in part. The handlebar assembly 110 can include a frame unit 225 having a mechanical frame connector, such as the mechanical frame connector 505 or the face plate 800. The frame unit 225 can include an electrical frame connector, such as the electrical frame connector 510 or the electrical frame connector 1410. The handlebar assembly can include a handlebar 205 to couple with the frame unit 225. The handlebar 205 can include a handle 215. The handlebar 205 can include a plurality of handles 215. For example, the handlebar 205 can include a first handle 215 and a second handle 215. The handlebar 205 can include a single handle 215. For example, the handle 215 can be a singular curved body that defines first handle portion 430 (e.g., a left handle) and a second handle portion 440 (e.g., a right handle) extending from a central handle portion 435. The handlebar 205 can include a handlebar connector, such as the mechanical handlebar connector 405 or the handlebar connector 1405. The handlebar connector can couple with the frame unit 225 to couple the handlebar 205 with the frame unit 225.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

In one or more examples, the present disclosure relates to a micromobility device (an example of which is a bicycle) configured to transport a rider and/or payload over short- to medium-distance trips and to operate in accordance with applicable mechanical, electrical, and operational safety standards. The micromobility device may be human-powered, electrically powered, or a hybrid thereof, and may include a structural body or frame configured to support one or more ground-engaging elements, a propulsion system, an energy storage system, a control system, and one or more rider or payload interfaces. The structural body may be rigid, semi-rigid, foldable, collapsible, telescoping, or modular, and may be formed from metal, polymer, composite, or hybrid materials, with mounting points for propulsion components, suspension elements, steering assemblies, braking systems, energy storage units, cargo accessories, and user-contact components such as seats, handlebars, platforms, pedals, or footrests. The micromobility device may include one or more ground-engaging elements such as wheels, rollers, tracks, or other rolling interfaces arranged in inline, staggered, or side-by-side configurations, with two, three, or more such elements depending on stability, maneuverability, or load requirements.

In various embodiments, the micromobility device may be designed to support a gross vehicle weight, defined as the combined mass of the device, rider, payload, and accessories, that corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with consumer safety regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and safety monitoring elements configured to meet or exceed applicable electrical safety standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or safety features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An integrated user-replaceable handlebar assembly, comprising:
a frame unit configured to couple with a frame of a micromobility device, the frame unit including a release element including at least one biasing element that is configured to be actuated by a user of the micromobility device without use of tools to removably couple the frame unit with a handlebar;
a user interface including a screen;
a brake system including a closed hydraulic circuit including a hydraulically actuated brake handlebar connector; and
the handlebar including:
an electrical handlebar connector, a mechanical handlebar connector, and the hydraulically actuated brake handlebar connector, all configured to be removably couplable to the frame unit through actuation of the release element.

2. The integrated user-replaceable handlebar assembly of claim 1, wherein the mechanical handlebar connector includes a recess configured to receive the at least one biasing element of the release element of the frame unit.

3. The integrated user-replaceable handlebar assembly of claim 1, wherein the hydraulically actuated brake handlebar connector is positioned within the mechanical handlebar connector, the handlebar assembly comprising:
the frame unit including:
a channel configured to receive the mechanical handlebar connector; and
a hydraulically actuated brake frame connector positioned within the channel, the hydraulically actuated brake frame connector configured to interface with the hydraulically actuated brake handlebar connector.

4. The integrated user-replaceable handlebar assembly of claim 1, comprising the frame unit including a channel configured to receive the mechanical handlebar connector, the at least one biasing element extending into the channel,
wherein the mechanical handlebar connector includes a recess configured to receive the at least one biasing element.

5. The integrated user-replaceable handlebar assembly of claim 1, comprising the frame unit including an electrical frame connector coupled with an energy storage system of the micromobility device, the electrical frame connector configured to receive the electrical handlebar connector to couple the handlebar with the energy storage system.

6. The integrated user-replaceable handlebar assembly of claim 1, comprising:
the handlebar including;
a handle; and
a brake controller coupled with the handle and with the hydraulically actuated brake handlebar connector, the brake controller configured to receive user inputs and to control the brake system based on the user inputs.

7. The integrated user-replaceable handlebar assembly of claim 1, comprising:
the handlebar including;
the hydraulically actuated brake handlebar connector including at least one piston cylinder, the hydraulically actuated brake handlebar connector positioned within the mechanical handlebar connector; and
a brake controller coupled with the hydraulically actuated brake handlebar connector and configured to receive user inputs, the brake controller configured to actuate the at least one piston cylinder based on the user inputs; and
the frame unit including:
a channel configured to receive the mechanical handlebar connector; and
a hydraulically actuated brake frame connector including at least one master cylinder positioned within the channel, the hydraulically actuated brake frame connector configured to interface with the hydraulically actuated brake handlebar connector such that the actuation of the at least one piston cylinder causes actuation of the at least one master cylinder.

8. The integrated user-replaceable handlebar assembly of claim 1, wherein the at least one biasing element includes an anchor configured to move between a locked position, in which the anchor engages with the handlebar, and an unlocked position, in which the anchor disengages from the handlebar, based on a user input via the user interface.

9. A micromobility device, comprising:
at least one wheel;
a steering member configured to control a direction of at least one of the at least one wheel;
a frame unit coupled with the steering member, the frame unit including a release element including at least one biasing element that is configured to be actuated by a user of the micromobility device without use of tools to removably couple the frame unit with a handlebar;
a user interface including a screen;
the handlebar including:
an electrical handlebar connector and a mechanical handlebar connector both configured to be removably couplable to the frame unit through actuation of the release element.

10. The micromobility device of claim 9, comprising:
a brake system including a closed hydraulic circuit including a hydraulically actuated brake handlebar connector; and
the handlebar including the electrical handlebar connector, the mechanical handlebar connector, and the hydraulically actuated brake handlebar connector, all configured to be removably couplable to the frame unit through actuation of the release element.

11. The micromobility device of claim 9, wherein the mechanical handlebar connector includes a recess configured to receive the at least one biasing element of the release element of the frame unit.

12. The micromobility device of claim 9, comprising:
a brake system including a closed hydraulic circuit including a hydraulically actuated brake handlebar connector, the hydraulically actuated brake handlebar connector positioned within the mechanical handlebar connector; and
the frame unit including:
a channel configured to receive the mechanical handlebar connector; and
a hydraulically actuated brake frame connector positioned within the channel, the hydraulically actuated brake frame connector configured to interface with the hydraulically actuated brake handlebar connector.

13. The micromobility device of claim 9, comprising the frame unit including a channel configured to receive the mechanical handlebar connector, the at least one biasing element extending into the channel,
wherein the mechanical handlebar connector includes a recess configured to receive the at least one biasing element.

14. The micromobility device of claim 9, comprising the frame unit including an electrical frame connector coupled with an energy storage system of the micromobility device, the electrical frame connector configured to receive the electrical handlebar connector to couple the handlebar with the energy storage system.

15. The micromobility device of claim 9, comprising:
a brake system including a closed hydraulic circuit including a hydraulically actuated brake handlebar connector; and
the handlebar including;
the hydraulically actuated brake handlebar connector;
a handle; and
a brake controller coupled with the handle and with the hydraulically actuated brake handlebar connector, the brake controller configured to receive user inputs and to control the brake system based on the user inputs.

16. The micromobility device of claim 9, comprising:
a brake system including a closed hydraulic circuit including a hydraulically actuated brake handlebar connector;
the handlebar including;
the hydraulically actuated brake handlebar connector including at least one piston cylinder, the hydraulically actuated brake handlebar connector positioned within the mechanical handlebar connector; and
a brake controller coupled with the hydraulically actuated brake handlebar connector and configured to receive user inputs, the brake controller configured to actuate the at least one piston cylinder based on the user inputs; and
the frame unit including:
a channel configured to receive the mechanical handlebar connector; and
a hydraulically actuated brake frame connector including at least one master cylinder positioned within the channel, the hydraulically actuated brake frame connector configured to interface with the hydraulically actuated brake handlebar connector such that the actuation of the at least one piston cylinder causes actuation of the at least one master cylinder.

17. The micromobility device of claim 9, wherein the at least one biasing element includes an anchor configured to move between a locked position, in which the anchor engages with the handlebar, and an unlocked position, in which the anchor disengages from the handlebar, based on a user input via the user interface.

18. A method of producing an integrated user-replaceable handlebar assembly, comprising:
providing a frame unit including a release element, the release element including at least one biasing element that is configured to be actuated by a user of a micromobility device without use of tools to removably couple the frame unit with a handlebar;
coupling a user interface including a screen with the frame unit; and
providing a handlebar including an electrical handlebar connector and a mechanical handlebar connector both configured to be removably couplable to the frame unit through actuation of the release element.

19. The method of claim 18, comprising:
positioning a recess on the mechanical handlebar connector, the recess configured to receive the at least one biasing element of the release element of the frame unit.

20. The method of claim 18, comprising:
providing a brake system including a closed hydraulic circuit including a hydraulically actuated brake handlebar connector.
